(19) United States
(12) Patent Application Publication
(10) Pub. No.: US 2016/0299216 A1
(43) Pub. Date: Oct. 13, 2016

(54) AXIAL MISALIGNMENT DETERMINATION APPARATUS

(71) Applicant: DENSO CORPORATION, Kariya-city (JP)

(72) Inventor: Yuusuke Matsumoto, Kariya-city (JP)

(21) Appl. No.: 15/093,102

(22) Filed: Apr. 7, 2016

(30) Foreign Application Priority Data
Apr. 8, 2015 (JP) 2015-079441

(51) Int. Cl. G01S 7/40; G01S 13/04; G01S 7/35

(52) U.S. Cl. CPC G01S 7/4026; G01S 7/35; G01S 13/04; G01S 2007/403; G01S 2007/4034

(57) ABSTRACT

In an axial misalignment determination apparatus mounted on a mobile object, a misalignment determiner performs axial misalignment determination processing to determine whether or not a reference axis of a transceiver for transmitting and receiving probe waves and a mounting reference axis of the mobile object coincide in direction. A necessity determiner determines whether or not a condition for performing the axial misalignment determination processing is met, and if the condition is met, determines that there is a need to perform the axial misalignment determination processing.

The condition is predefined based on an extrapolation result of an extrapolator for extrapolating a target and a determination result of a deposit determiner for determining the presence or absence of a deposit on an object. If it is determined by the necessity determiner that there is a need to perform the axial misalignment determination processing, the misalignment determiner performs the axial misalignment determination processing.

### CROSS-REFERENCE TO RELATED APPLICATION

This application is based on and claims the benefit of priority from earlier Japanese Patent Application No. 2015-79441 filed Apr. 8, 2015, the description of which is incorporated herein by reference.

### BACKGROUND

1. Technical Field The present invention relates to an axial misalignment determination apparatus for determining the need for axial misalignment determination processing to be performed in a target detection apparatus, based on a result of transmitting and receiving probe waves.

2. Related Art

Conventionally, a target detection apparatus is known that is mounted on a mobile object and configured to detect a target reflecting probe waves based on a result of transmitting and receiving the probe waves, as disclosed in Japanese Patent Application Laid-Open Publication No. 2010-281584.

Such a type of target detection apparatus includes a transceiver configured to transmit and receive probe waves via antennas in each defined measurement cycle, and a controller configured to detect a target based on a result of transmitting and receiving the probe waves.

The controller of the target detection apparatus is configured to predict, for each of previous-cycle targets that are targets detected in an executed measurement cycle immediately previous to the current cycle, a predicted position to be detected in the current cycle, and if no target is detected at the predicted position in the current cycle, extrapolate at the predicted position a provisional target that is treated as if it were actually detected at the predicted position in the current cycle. If the same target is detected consecutively a defined number of times or more, then the same target is determined to be a target that is likely to be present, thus recognized as an actual target.

In the case of the target detection apparatus mounted on a mobile object, a reference axis of the target detection apparatus coincides in direction with a mounting reference axis of the mobile object so that a predefined area can be irradiated with the probe waves.

In the target detection apparatus mounted on the mobile object as above, vibration caused by movement of the mobile object and aging of the target detection apparatus may result in axial misalignment of the reference axis of the target detection apparatus with the mounting reference axis of the mobile object in a vertical direction (which is a vehicle height direction). The axial misalignment may reduce the target detection accuracy.

Therefore, in the target detection apparatus, a determination is performed as to whether or not the axial misalignment has occurred. Such an axial misalignment determination, however, may increase a processing load. Thus, it is desired to perform the axial misalignment determination processing only in situations where it is likely that the axial misalignment has occurred.

To this end, for example, the target detection apparatus may be configured to perform the misalignment determination if more extrapolations have been performed. This is because the axial misalignment may increase lengths of paths from transmission to receipt of the probe waves and thus lower receive levels of the probe waves or reflections, which makes it difficult to detect a target and thus results in an increasing number of extrapolations to be performed.

In addition, a deposit, such as snow or contamination or the like, on the target, may absorb the probe waves. Thus, in the target detection apparatus, the receive levels of the reflected probe wave or reflections may be lowered. That is, in the target detection apparatus, also in the presence of a deposit, such as snow or contamination or the like, on the target, an increasing number of extrapolations will be performed.

The conventional techniques, however, are unable to determine whether the increase in extrapolations is caused by the axial misalignment or by the deposit on the target.

Thus, there is a problem with the conventional techniques that the deposit on the target may also lead to the determination that it is likely that the axial misalignment has occurred and the misalignment determination may be performed accordingly.

In consideration of the foregoing, exemplary embodiments of the present invention are directed to providing techniques for increasing accuracy of determining whether or not to perform the axial misalignment determination processing.

### SUMMARY

In accordance with an exemplary embodiment of the present invention, there is provided an axial misalignment determination apparatus including a transceiver, a detector, a predictor, an extrapolator, a target determiner, a sensor, a deposit determiner, a misalignment determiner, and a necessity determiner.

The transceiver is configured to transmit and receive probe waves via antennas every defined measurement cycle. The detector is configured to, based on the probe waves transmitted and received by the transceiver, detect targets that have reflected the probe waves.

The predictor is configured to predict, for each of previous-cycle targets that are target candidates detected in a previous measurement cycle, a predicted position of a current-cycle target that is a target candidate corresponding to the previous-cycle target and expected to be detected in a current measurement cycle immediately subsequent to the previous measurement cycle.

The extrapolator is configured to, for each of the previous-cycle targets, if the current-cycle target corresponding to the previous-cycle target is undetected in the current cycle at the predicted position acquired by the predictor, extrapolate at the predicted position the current-cycle target that is treated as if it were actually detected at the predicted position in the current cycle. The target determiner is configured to, for each of target candidates, if the target candidate has been detected in succession for at least a defined number of measurement cycles, determine that the target is actually present.

The sensor is configured to sense at least part of a transmission range to be irradiated with the probe waves using a sensing method other than a method of transmitting and receiving the probe waves. The deposit determiner is configured to, based on a sensing result of the sensor, determine the presence or absence of a deposit on an object present in the at least part of the transmission range.

The misalignment determiner is configured to perform axial misalignment determination processing to determine whether or not a reference axis of the antennas and a mounting reference axis of the mobile object fail to coincide in direction with each other, that is, whether or not the reference axis of the antennas and the mounting reference axis of the mobile object are axially misaligned with each other. The necessity determiner is configured to determine whether or not a condition for performing the axial misalignment determination processing is met, and if the condition is met, then determine that there is a need to perform the axial misalignment determination processing. The condition is predefined based on an extrapolation result of the extrapolator and a determination result of the deposit determiner.

In the apparatus, the misalignment determiner is configured to, if it is determined by the necessity determiner that there is a need to perform the axial misalignment determination processing, perform the axial misalignment determination processing.

In the target detection apparatus configured as above, if the condition for performing the axial misalignment determination processing is not met, performance of the axial misalignment determination processing is to be avoided.

With this configuration of the target detection apparatus, only if it is likely that the axial misalignment has occurred, the axial misalignment determination processing is allowed to be performed. Therefore, the axial misalignment determination apparatus can increase accuracy of determining whether or not to perform the axial misalignment determination processing.

### BRIEF DESCRIPTION OF THE DRAWINGS

FIG. 1 is block diagram of a target detection system in accordance with one embodiment of the present invention;

FIG. 2A is a functional block diagram of an image processor;

FIG. 2B is a functional block diagram of a signal processor;

FIG. 2C is a functional block diagram of an electronic control unit;

FIG. 3 is a flowchart of target detection processing to be performed in the signal processor; and

FIG. 4 is a flowchart of necessity determination processing to be performed in the electronic control unit.

### DESCRIPTION OF SPECIFIC EMBODIMENTS

The present invention will be described more fully hereinafter with reference to the accompanying drawings.

### (Target Detection System)

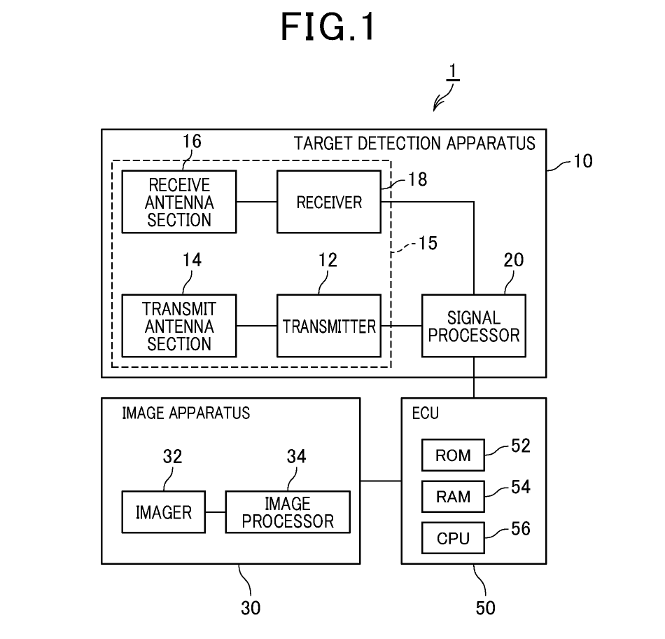

A target detection system 1 shown in FIG. 1 is used onboard a four-wheeled vehicle that is hereinafter referred to as an own vehicle.

The target detection system 1 is configured to detect objects located around the own vehicle.

The target detection system 1 includes a target detection apparatus 10, an imaging unit 30, and an electronic control unit (ECU) 50.

The target detection apparatus 10 is configured to transmit probe waves that are electromagnetic waves in the millimeter waveband and receive incoming waves that are reflected probe waves, and based on the received incoming waves, detect targets that have reflected the probe waves. As used herein, the term “targets” refer to sources of the incoming waves, including objects on a roadway and objects located around the roadway. The objects include, but are not limited to, automobiles, roadside objects, traffic lights, pedestrians, buildings and others.

The target detection apparatus 10 includes a transmitter 12, a transmit antenna section 14, a receive antenna section 16, a receiver 18, and a signal processor 20.

The transmitter 12 is configured to generate probe waves according to signals from the signal processor 20. Each probe wave generated in the transmitter 12 is a frequency-modulated continuous wave such that one modulation period has an ascent interval in which the frequency is progressively increasing with time and a descent interval in which the frequency is progressively decreasing with time. That is, in the present embodiment, the target detection apparatus 10 is a well-known frequency-modulated continuous-wave (FM-CW) radar.

The transmit antenna section 14 emits the probe waves generated in the transmitter 12. In the present embodiment, the transmit antenna section 14 may be formed of a single antenna element or a plurality of antenna elements. The transmit antenna section 14 is arranged to transmit the probe waves in a forward direction of the own vehicle. In the present embodiment, an area irradiated with the probe waves is referred to as a transmission range.

The receive antenna section 16 includes a plurality of antenna elements for receiving the incoming waves. As used herein, the term “incoming waves” include reflections of the probe waves emitted from the transmit antenna section 14 from the targets.

The antenna elements of the transmit and receive antenna sections 14 and 16 are arranged such that the reference axis of each of the antenna sections 14 and 16 coincides in direction with the mounting reference axis of the four-wheeled vehicle not only in the vertical direction (i.e., the vehicle-height direction) of the four-wheeled vehicle, but also in the horizontal direction (i.e., the widthwise direction).

The receiver 18 is configured to perform pre-processing required to detect the targets on the incoming waves received at the receive antenna section 16. The pre-processing includes generating beat signals by mixing the incoming waves with the probe waves, sampling the beat signals, and removing noise from the beat signals. As shown in FIG. 1, the transmitter 12, the receiver 18, and the antenna sections 14 and 16 form a transceiver 15 configured to transmit and receive the probe waves every defined measurement cycle.

The signal processor 20 includes at least one well-known microcomputer. The signal processor 20 is configured to detect the targets by well-known processing based on the beat signals generated in the receiver 18 and measure positions and relative speeds of the targets.

The signal processor 20 includes at least one processor (e.g., a digital signal processor (DSP)) configured to perform fast Fourier transform (FFT) processing or the like on data from the receiver 18.

### (Imaging Unit)

The imaging unit 30 includes an imager 32 and an image processor 34. The imager 32 has a well-known configuration to capture images. The imager 32 is arranged to capture images of at least part of transmission range of the target detection apparatus 10.

The image processor 34 is configured to perform image processing on the images captured by the imager 32. The image processing includes deposit determination processing for determine the presence or absence of a deposit on each object located within the transmission range.

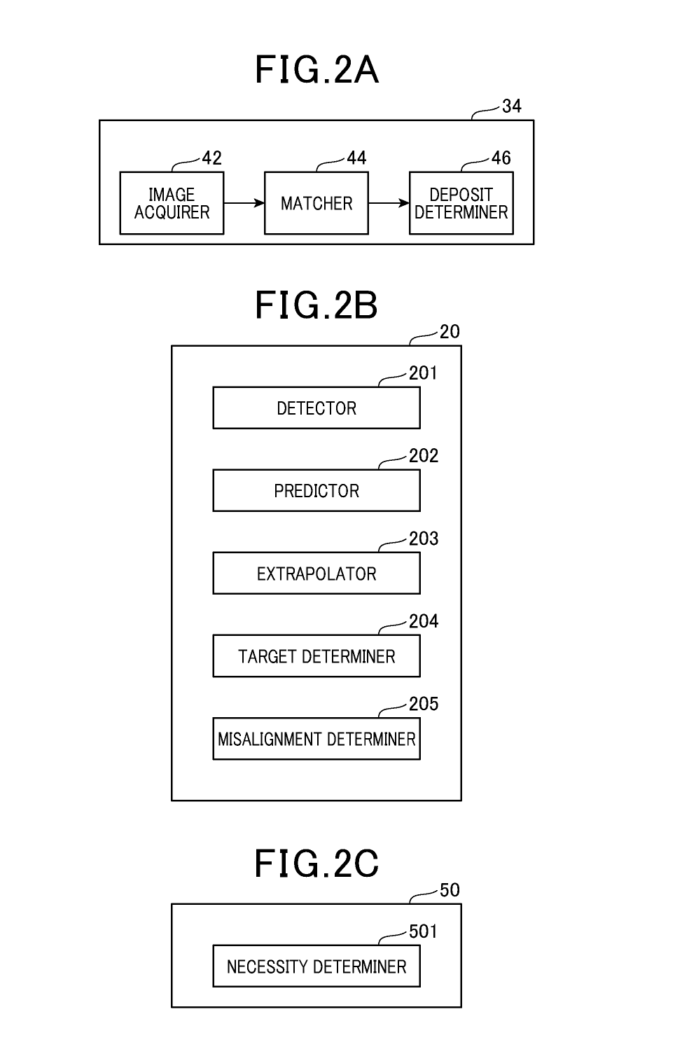

FIG. 2A shows functional blocks for performing deposit determination processing.

The image processor 34 includes, as functional blocks to perform the deposit determination processing, an image acquirer 42, a matcher 44, and a deposit determiner 46. The image processor 34 may be formed of a well-known microcomputer including a read only memory (ROM), a random access memory (RAM), a central processing unit (CPU). Functions of these functional blocks may be implemented by the CPU (not shown) executing programs stored in the ROM (not shown) or the like to perform the deposit determination processing.

The image acquirer 42 is configured to acquire images captured by the imager 32. The matcher 44 is configured to perform template matches on each image acquired by the image acquirer 42 to identify objects to be detected that are shown in the image. Each template used in the matcher 44 represents an object to be detected. These templates are produced beforehand by experiment. As used herein, the term “object to be detected” refers to an object that is likely to be present around the own vehicle, such as an automobile (e.g., a preceding vehicle), a signboard, a roadside object (e.g., a guardrail or the like).

The deposit determiner 46 is configured to determine the presence or absence of a deposit on each object detected in the matcher 44. For example, the deposit determiner 46 may be configured to, if a degree of brightness of an area where an object to be detected is shown in the image is equal to or greater than a reference value that is a degree of brightness in the absence of a deposit on the object or a degree of brightness of deposit-free part of the object, determine that there is a deposit on the object to be detected.

As used herein, the term “deposit” refers to a substance that absorbs the probe waves. In the present embodiment, the deposit may include snow, water droplets, dirt, dust or the like.

### (Electronic Control Unit (ECU))

The ECU 50 is formed of a well-known microcomputer including a read only memory (ROM) 52, a random access memory (RAM) 54, a central processing unit (CPU) 56. The ROM 52 stores data and programs that need to be stored even when power is off. The RAM 54 transiently stores data. The CPU 56 performs processing according to programs stored in the ROM 52 or the like.

The ROM 52 in the ECU 50 stores processing programs for the ECU 50 to perform necessity determination processing to determine whether or not the axial misalignment determination processing needs to be performed.

### (Target Detection Processing)

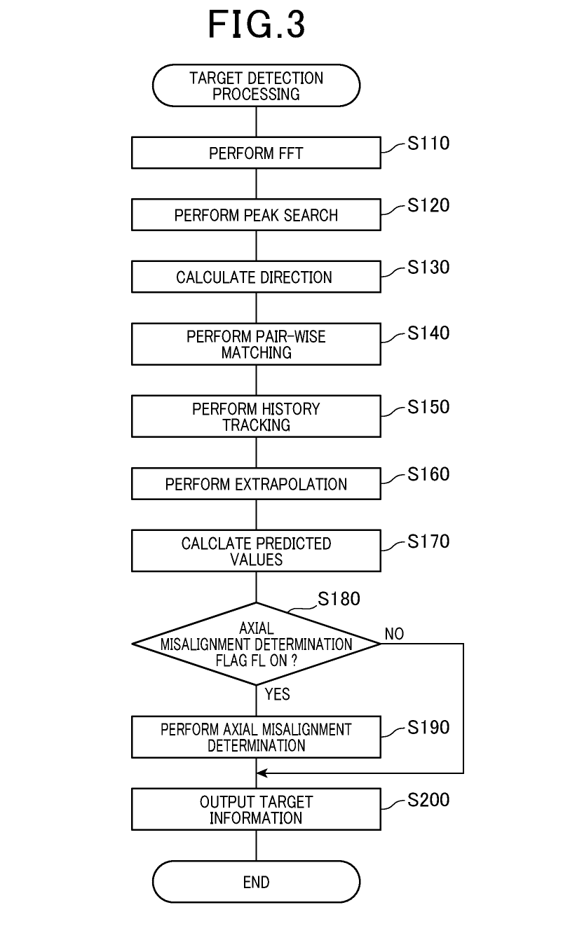

The target detection processing to be performed in the target detection apparatus 10, particularly, in the signal processor 20, will now be explained with reference to FIGS. 2B and 3. As shown in FIG. 2B, the signal processor 20 includes, as functional blocks to perform the target detection processing, a detector 201, a predictor 202, an extrapolator 203, a target determiner 204, a misalignment determiner 205. Functions of these functional blocks may be implemented by the CPU (not shown) executing programs stored in the ROM (not shown) or the like to perform the target detection processing.

The target detection processing is repeatedly launched every measurement cycle, that is, every modulation period for the probe waves.

When the target detection processing is launched, the detector 201 of the signal processor 20, in step S110 shown in FIG. 3, performs frequency analysis (e.g., Fast Fourier Transform (FFT)) on sampled data accumulated for one modulation period in the measurement cycle immediately previous to the current measurement cycle. One modulation period corresponds to one measurement cycle. Using the frequency analysis, the detector 201 calculates a power spectrum of the beat signal BT for each of the ascent and descent intervals and for each of channels assigned to the respective antenna elements forming the receive antenna section 16.

Subsequently, in step S120, the detector 201 of the signal processor 20 performs a well-known peak search to extract power spectral peak frequency components of the beat signal BT (hereinafter referred to as peak frequency components) acquired in step S110 for each of the ascent and descent intervals.

In step S130, for each peak frequency component extracted in step S120 and for each of the ascent and descent intervals, the detector 201 of the signal processor 20 performs direction calculation processing to calculate an incoming direction of the incoming wave contributing to the peak frequency component. In the direction calculation processing, the detector 201 performs frequency analysis on same-frequency components acquired from the respective channels. The frequency analysis of the direction calculation processing may include, but is not limited to, FFT processing, and super-resolution imaging such as multiple signal classification (MUSIC).

Subsequently, in step S140, the detector 201 of the signal processor 20 performs well-known pair-wise matching to establish pair-wise combinations between peak frequency components for the ascent interval and peak frequency components for the descent interval such that between the peak frequency components of the same pair-wise combination a difference in peak frequency signal level calculated in step S130 is equal to or less than a defined threshold and a difference in incoming direction calculated in step S130 is within a defined angle range. For each pair-wise combination, using a well-known technique for the FM-CW radar, the detector 201 of the signal processor 20 calculates a distance and a relative speed to the own vehicle and registers the calculated distance and relative speed in association with the pair-wise combination of peak frequency components. In the following, the registered pair-wise combination of peak frequency components will be referred to as a frequency pair.

Further, in step S150, for each frequency pair in the current cycle registered in step S140 (hereinafter referred to as a current-cycle target), the detector 201 of the signal processor 20 performs history tracking to determine whether or not the current-cycle target and one of previous-cycle targets are the same, that is, the current-cycle target and one of previous-cycle targets are historically connected. The previous-cycle targets are frequency pairs (i.e., target candidates) detected in the executed measurement cycle immediately previous to the current cycle.

In the history tracking of the present embodiment, the target determiner 204 of the signal processor 20, if a difference between a predicted position of one of the previous-cycle targets calculated by the predictor 202 in step S170 (described later) and the detected position of the current-cycle target is less than a predefined upper limit difference in position and if a difference between a predicted relative speed of the one of the previous cycle targets calculated by the predictor 202 in step S170 (described later) and the detected relative speed of the current-cycle target is less than a predefined upper limit difference in relative speed, determines that the current cycle target and the one of the previous-cycle target are historically connected. If the presence of such historical connectability is established for plural consecutive cycles (e.g., five consecutive cycles), then it is determined that such a frequency pair is determined to be a target.

The current-cycle target sequentially takes over information of the previous-cycle target that is historically connected to the current-cycle target. The information of the previous-cycle target includes the number of times histories have been connected, an extrapolation counter and an extrapolation flag (described later).

Subsequently, in step S160, the extrapolator 203 of the signal processor 20, if no current-cycle target is detected in the current cycle, corresponding to the predicted position and relative speed calculated in step S170 in the immediately previous cycle, extrapolate a current-cycle target having the predicted position and relative speed in step S160. Such a current-cycle target is treated as if it were actually detected the predicted position.

The extrapolation flag and the extrapolation counter are set in each current-cycle target, where the extrapolation flag indicates whether or not the current-cycle target has been extrapolated and the extrapolation counter indicates the number of times the current-cycle target has been extrapolated in succession. The extrapolation flag and the extrapolation counter are to be cleared if the frequency pair having the predicted position and relative speed is actually detected. If the frequency pair (regarded as a target candidate) having the predicted position and relative speed is not detected, the extrapolation flag is set ON and the extrapolation counter is incremented by one. If a count value of the extrapolation counter has reached a predefined discarding threshold (as a specific defined number that is less than the defined number), the target candidate is discarded assuming that it has been lost.

Subsequently, in step S170, the predictor 202 of the signal processor 20 calculates, for each current-cycle target registered in step S150, a predicted position (i.e., a distance and a direction) and a predicted speed relative to the own vehicle to be measured in the subsequent measurement cycle in a well-known manner using a Kalman filter or the like.

Further, in step S180, the misalignment determiner 205 of the signal processor 20 determines whether or not an axial misalignment determination flag (described later) is ON.

If in step 180 it is determined that axial misalignment determination flag FL is ON, then in step S190 the misalignment determiner 205 of the signal processor 20 performs axial misalignment determination processing to determine whether or not the reference axis and the mounting reference axis fail to coincide in direction with each other. If an aggregation of results of the frequency analysis performed in step S110 over a plurality of measurement cycles (i.e., the spectral distribution) indicates that a peak intensity at a frequency where the road surface reflection intensity becomes maximal is lower than an intensity at a frequency corresponding to a predefined distance, it may be determined that the reference axis and the mounting reference axis fail to coincide in direction with each other. Thereafter, the process flow proceeds to step S200.

If in step S180 it is determined that the axial misalignment determination flag FL is OFF, then the process flow proceeds to step S200.

In step S200, the signal processor 20 outputs, to the ECU 50, information including a position (i.e., a distance and an azimuth angle) and a speed of each recognized target relative to the own vehicle. Thereafter, the process flow ends.

### (Necessity Determination Processing)

Necessity determination processing to be performed in the ECU 50 will now be explained. This necessity determination processing is launched every predefined timing, for example, every measurement cycle. As shown in FIG. 2C, the ECU 50 includes a necessity determiner 501 as a functional block to perform the necessity determination processing. The necessity determiner 501 may be implemented by the CPU 56 executing programs stored in the ROM 52 (see FIG. 1) or the like to perform the necessity determination processing.

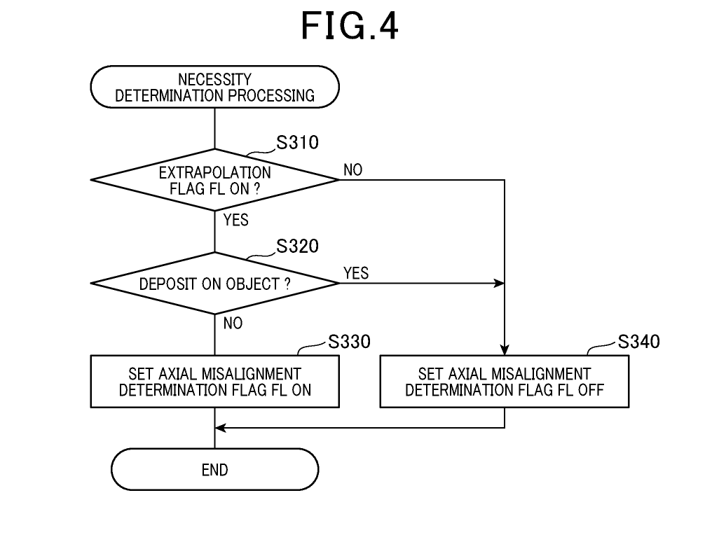

Referring to FIG. 4, when the necessity determination processing is launched, the necessity determiner 501 of the ECU 50, in step S310, determines whether or not an extrapolation flag related condition is met. In the present embodiment, in step S310, the extrapolation flag related condition is that at least one extrapolation flag FL is ON. That is, the extrapolation flag related condition is that at least one current-cycle target is extrapolated. Alternatively, the extrapolation flag related condition may be that a plurality of extrapolation flags are ON. Still alternatively, in step S310, the extrapolation flag related condition may be that at least one extrapolation flag FL is ON and a value of its corresponding extrapolation counter is equal to or greater than one. Still alternatively, in step S310, the extrapolation flag related condition may be that at least one extrapolation flag FL is ON and a value of its corresponding extrapolation counter is equal to or greater than a set number. The set number refers to the number of measurement cycles that is less than the defined number.

If in step S310 YES is determined, the process flow proceeds to step S320.

In step S320, the necessity determiner 501 of the ECU 50 determines whether or not a deposit related condition is met, based on a result of the deposit determination processing performed in the imaging unit 30. The deposit related condition is that there is a deposit on an object detected in the imaging unit 30. That is, in step S320, the necessity determiner 501 of the ECU 50 determines the presence or absence of a deposit on the object. If in step S320 it is determined that there is no deposit on the object, then in step S330 the necessity determiner 501 of the ECU 50 sets the axial misalignment determination flag (FL) ON. In the present embodiment, the axial misalignment determination flag refers to a flag indicative of the presence or absence of the need for performing the axial misalignment determination processing. If the axial misalignment determination flag is ON, the axial misalignment determination processing needs to be performed. If the axial misalignment determination flag is OFF, the axial misalignment determination processing does not have to be performed.

The extrapolation flag related condition and the deposit related condition form a condition for performing the axial misalignment determination processing. If the condition for performing the axial misalignment determination processing is met, that is, if the extrapolation flag related condition and the deposit related condition are both met, it is determined that there is a need to perform the axial misalignment determination processing. If the condition for performing the axial misalignment determination processing is not met, that is, if at least one of the extrapolation flag related condition and the deposit related condition is not met, performance of the axial misalignment determination processing is to be avoided.

Thereafter, the process flow ends. In the necessity determination processing, if in step S310 it is determined that the extrapolation flags are OFF or if in step S320 it is determined that there is a deposit on the object, then in step S340, the necessity determiner 501 sets the axial misalignment determination flag OFF. Thereafter, the process flow ends.

### (Advantages)

In the necessity determination processing as described above, the axial misalignment determination processing is performed if at least one current-cycle target is extrapolated in the target detection processing and if no deposit is detected on the object in the deposit determination processing. That is, a condition for performing the axial misalignment determination processing is that at least one current-cycle target is extrapolated and no deposit is detected on the object.

In the target detection system 1, if no current-cycle target is extrapolated in the target detection processing even if no deposit is detected in the deposit determination processing, the axial misalignment determination processing does not have to be performed. In the target detection system 1, if a deposit is detected on the object in the deposit determination processing even if at least one current-cycle target is extrapolated in the target detection processing, the axial misalignment determination processing does not have to be performed.

That is, in the target detection system 1, only if it is likely that the axial misalignment has occurred, the axial misalignment determination processing is allowed to be performed.

Therefore, the axial misalignment determination apparatus can increase accuracy of determining whether or not to perform the axial misalignment determination processing.

In the target detection processing, setting the extrapolation flag ON after extrapolating the current-cycle target the set number of times or more in succession can prevent the axial misalignment determination processing from being performed in cases where the target eventually fails to be detected.

Therefore, the target detection system 1 can prevent unnecessary processing from being performed.

Further, the target detection system 1 is configured to determine the presence or absence of a deposit on the object based on the captured images. Therefore, the target detection system 1 can increase the accuracy of determining whether or not to perform the axial misalignment determination processing, and can thus accurately determine the need to perform the axial misalignment determination processing.

### (Modifications)

It is to be understood that the invention is not to be limited to the specific embodiment disclosed above and that modifications and other embodiments are intended to be included within the scope of the appended claims.

In the above embodiment, the signal processor 20 of the target detection apparatus 10 is configured to perform the target detection processing. Alternatively, the ECU 50 may be configured to perform the target detection processing.

In the above embodiment, the ECU 50 is configured to perform the necessity determination processing. Alternatively, the signal processor 20 of the target detection apparatus 10 may be configured to perform the necessity determination processing.

In the above embodiment, the target detection apparatus 10 includes the FM-CW radar. Alternatively, the target detection apparatus 10 may include a pulse radar or a two frequency radar or the like.

In the above embodiment, the target detection apparatus 10 is configured to emit the electromagnetic waves in the millimeter waveband. Alternatively, the target detection apparatus 10 may be configured to emit light waves as probe waves. That is, the target detection apparatus 10 may include a laser radar. Still alternatively, the target detection apparatus 10 may be configured to emit sound waves as probe waves. That is, the target detection apparatus 10 may include a sonar. For example, if the laser radar is used as the target detection apparatus, the axial misalignment determination may be implemented by a well-known technique as disclosed in Japanese Patent Application Laid-Open Publication No. H10-132939, the disclosure of which is hereby incorporated herein by reference.

In the above embodiment, the deposit determiner 46 is configured to, if a degree of brightness of an area where an object to be detected is shown is equal to or greater than a reference value, then determine that there is a deposit on the object. Alternatively, the deposit determiner 46 is configured to, if a degree of saturation of an area where an object to be detected is shown is equal to or greater than a reference value, then determine that there is a deposit on the object. Still alternatively, the deposit determiner 46 is configured to, if a degree of brightness of an area where an object to be detected is shown is equal to or greater than a reference value and if a degree of saturation of the area is equal to or greater than a reference value, then determine that there is a deposit on the object.

In the above embodiment, the imaging unit 30 is configured to perform the deposit determination processing. Alternatively, a laser radar having a higher resolution than the target detection apparatus 10 may be configured to perform the deposit determination processing. Still alternatively, a sensing device other than the imaging unit 30 and the laser radar, such as a sensing device using a sensing method other than transmitting and receiving the probe waves, may be configured to perform the deposit determination processing.

In the above embodiment, if the extrapolation flags are OFF or if there is a deposit on the object, it is determined the axial misalignment determination processing does not have to be performed. Alternatively, if the extrapolation flags are OFF and if there is a deposit on the object, it may be determined that the axial misalignment determination processing does not have to be performed.

The present invention is not in any way limited to the above embodiment. Further, an embodiment with part of the above configuration omitted while it remains capable of solving the problem is also included in the embodiments of the present invention. Further, an embodiment configured by combining a plurality of the above embodiments as appropriate is also included in the embodiments of the present invention. Any embodiment which could be made without departing from the spirit of the invention as defined solely by the terms in the appended claims is included in the embodiments of the present invention.

The present invention can also be implemented in numerous ways other than as the axial misalignment determination apparatus set forth above, for example, as a computer readable medium such as a computer readable storage medium or a computer network wherein program instructions are executed to implement various functions of the axial misalignment determination apparatus.

What is claimed is:

1. An axial misalignment determination apparatus mounted on a mobile object, the apparatus comprising:
a transceiver configured to transmit and receive probe waves via antennas every defined measurement cycle;
a detector configured to, based on the probe waves transmitted and received by the transceiver, detect targets that have reflected the probe waves;
a predictor configured to predict, for each of previous-cycle targets that are target candidates detected in a previous measurement cycle, a predicted position of a current-cycle target that is a target candidate corresponding to the previous-cycle target and expected to be detected in a current measurement cycle immediately subsequent to the previous measurement cycle;
an extrapolator configured to, for each of the previous-cycle targets, if the current-cycle target corresponding to the previous-cycle target is undetected in the current cycle at the predicted position acquired by the predictor, extrapolate at the predicted position the current-cycle target that is treated as if it were actually detected at the predicted position in the current cycle;
a target determiner configured to, for each of target candidates, if the target candidate has been detected in succession for at least a defined number of measurement cycles, determine that the target is actually present;
a sensor configured to sense at least part of a transmission range to be irradiated with the probe waves using a sensing method other than a method of transmitting and receiving the probe waves;
a deposit determiner configured to, based on a sensing result of the sensor, determine the presence or absence of a deposit on an object present in the at least part of the transmission range;
a misalignment determiner configured to perform axial misalignment determination processing to determine whether or not a reference axis of the antennas and a mounting reference axis of the mobile object fail to coincide in direction with each other; and
a necessity determiner configured to determine whether or not a condition for performing the axial misalignment determination processing is met, and if the condition is met, then determine that there is a need to perform the axial misalignment determination processing, the condition being predefined based on an extrapolation result of the extrapolator and a determination result of the deposit determiner,
wherein the misalignment determiner is configured to, if it is determined by the necessity determiner that there is a need to perform the axial misalignment determination processing, perform the axial misalignment determination processing.

2. The apparatus of claim 1, wherein the misalignment determiner is configured to, if it is determined by the necessity determiner that the condition for performing the axial misalignment determination processing is not met, avoid performing the axial misalignment determination processing.

3. The apparatus of claim 1, wherein the condition for performing the axial misalignment determination processing is that at least one extrapolation is performed by the extrapolator for at least one of the previous-cycle targets detected by the detector and it is determined by the deposit determiner that there is no deposit on the object.

4. The apparatus of claim 3, wherein the misalignment determiner is configured to, if no extrapolations are performed for the previous-cycle targets detected by the detector or if it is determined by the deposit determiner that there is a deposit on the object, avoid performing the axial misalignment determination processing.

5. The apparatus of claim 1, wherein the condition for performing the axial misalignment determination processing is that for at least one of the current-cycle targets a set number, which is less than the defined number, or more of extrapolations are performed in succession by the extrapolator and it is determined by the deposit determiner that there is no deposit on the object.

6. The apparatus of claim 1, wherein
the sensor is configured to capture an image of the at least part of the transmission range, and
the deposit determiner is configured to, based on the image captured by the sensor, determine the presence or absence of a deposit on the object.

7. The apparatus of claim 1, wherein the target determiner is configured to, if for at least one of the current-cycle targets a specific defined number, which is less than the defined number, of extrapolations are performed in succession by the extrapolator, cease to detect the target.
